(19) United States
(12) Patent Application Publication
(10) Pub. No.: US 2006/0235848 A1
(43) Pub. Date: Oct. 19, 2006

(54) Method and apparatus for searching, filtering and sorting data in a wireless device

(75) Inventors: Kenneth Wallis, Oakville (CA); Michael Shenfield, Richmond Hill (CA); Bryan R. Goring, Milton (CA); David DeBruin, Guelph (CA); Laura Doktorova, Mississauga (CA); Kamen B. Vitanov, Mississauga (CA); Vlera Bibr, Kilbride (CA)

Correspondence Address: OGILVY RENAULT LLP, 1981 MCGILL COLLEGE AVENUE, SUITE 1600, MONTREAL, QC, H3A2Y3, CA

(73) Assignee: Research in Motion Limited

(21) Appl. No.: 11/360,774

(22) Filed: Feb. 24, 2006

Related U.S. Application Data
(60) Provisional application No. 60/672,079, filed on Apr. 18, 2005.

(51) Int. Cl. G06F 17/30

(52) U.S. Cl. 707/7

(57) ABSTRACT

There is shown and described a definition for defining searching, filtering and sorting requests which seeks to provide a more succinct and efficient language in order to minimize transmission size and parsing/processing requirements while facilitating common and useful search/filter/sort contingencies. The language allows for filtering a data set by comparing a single field of all instances of the data against a static or dynamic value, then, optionally, to order the result set in ascending or descending order. All instances in the data set may be obtained without searching/filtering.

### CROSS-REFERENCE TO RELATED APPLICATIONS

This application is based on, and claims benefit of 35 U.S.C. §119(e) of Provisional Patent Application No. 60/672,079 filed Apr. 18, 2005.

### TECHNICAL FIELD

This invention relates to the field of data processing. In particular, this invention pertains to a lightweight data management mechanism for searching, filtering and sorting data in a wireless device.

### BACKGROUND OF THE INVENTION

There are many existing languages for searching, filtering and sorting data, especially as part of any database solution. Such languages have been built to provide for every possible search, filter or sort contingency.

It will be appreciated that while such languages for searching, filtering and sorting data may be convenient when used for accessing powerful enterprise database solutions, such languages have drawbacks when used to access database comprised in devices having limited processing power. For instance, such languages for searching, filtering and sorting data are often too verbose and the parsing process can become too expensive for these devices in which processing power is limited.

Also when a communication is involved in the process, such as when the request for a search is performed over a network, prior art languages for searching, filtering and sorting data may be costly to use, especially in the case where bandwidth is limited and expensive such as for instance in the case where a satellite wireless link is used.

There is therefore a need for a method that will overcome at least one of the above-identified drawbacks.

### BRIEF DESCRIPTION OF THE DRAWINGS

Further features and advantages of the present invention will become apparent from the following detailed description, taken in combination with the appended drawings, in which:

FIG. 1. is a block diagram which shows a plurality of wireless user devices in which the invention may be implemented;

FIG. 2 is a block diagram which shows an embodiment of a user device;

FIG. 3 is a flowchart which shows how a search is performed according to a first embodiment of the invention; according to a first step a data search request is provided and according to a second step search results are provided;

FIG. 4 is a flowchart which shows how the data search request is performed according to a first embodiment of the invention;

FIG. 5 is a flowchart which shows how the data search request is performed according to a second embodiment of the invention in which search results sorting parameters are provided; and

FIG. 6 is a flowchart which shows how the search results sorting parameters are provided according to an embodiment.

It will be noted that throughout the appended drawings, like features are identified by like reference numerals.

### DETAILED DESCRIPTION

There is shown and described a definition for defining searching, filtering and sorting requests which seeks to provide a more succinct and efficient language in order to minimize transmission size and parsing/processing requirements while facilitating common and useful search/filter/sort contingencies. The language allows for filtering a data set by comparing a single field of all instances of the data against a static or dynamic value, then, optionally, to order the result set in ascending or descending order. All instances in the data set may be obtained without searching/filtering. Devices such as wireless devices may be provisioned with code (e.g. an interpreter of a runtime environment) to perform searches in response to requests conforming to the definition.

According to an embodiment of the invention, there is provided a method of searching data stored in a memory coupled to a processing device, the method comprising: provisioning the processing device with computer executable code for: accepting a request conforming to a definition for searching/filtering and ordering data, the definition comprising a first clause for specifying searching and filtering information to filter a data set in accordance with a single field of the set; and a second clause for specifying ordering information; and performing data operations in accordance with the request to provide determined instances of data in response.

According to another embodiment of the invention, there is provided a method for performing a search in instances of a data component, the method comprising: determining a data search request in accordance with a definition for lightweight data management to be performed on a single data field of the instances of the data component, comprising: receiving the single data field; receiving an operator to be used with the single data field; and receiving at least one corresponding operand to be used with the operator; and using the data search request generated to provide search results.

According to yet another embodiment of the invention, there is provided a method for specifying a data search request, comprising: providing a data search request in accordance with a definition for lightweight data management to be performed on a single data field of a data component, comprising: providing the single data field; providing an operator to be used with the single data field; and providing at least one corresponding operand to be used with the operator to instruct a search.

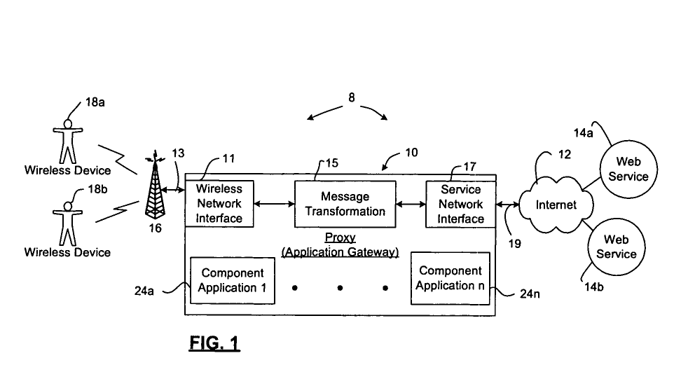

FIG. 1 illustrates one network system environment in which a language in accordance with the teachings herein is useful. FIG. 1 is a block diagram of a network 8 in which wireless device users 18a, 18b operate wireless devices to send web service request messages via a public domain carrier 16 to a stateful proxy which in one embodiment is an application gateway 10. The application gateway 10 forwards the web service request messages through a service network such as the Internet 12 to an appropriate web service 14a, 14b. The messages are processed by the appropriate web service 14a, 14b and returned through the Internet 12 to the application gateway 10. The public domain carrier 16 forwards the response messages to the wireless device 18a, 18b which processes the response and displays, as applicable, response content to the wireless device users.

The application gateway 10 supports a wireless network interface 11 having a link 13 to the wireless network 12. A message transformation function 15 receives messages from the wireless network interface 11 and processes the messages before forwarding the messages to a service network interface 17. The service network interface 17 has a link 19 to the service network 12 (the Internet, for example) over which it forwards the messages to an appropriate web service 14a, 14b.

In accordance with an embodiment of the invention, the application gateway 10 is provisioned with a plurality of component-based applications 24a, 24n which configure the gateway 10 for processing the various messages. Wireless devices 18a, 18b are also provisioned with at least portions of the component-based applications 24a, 24n to enable the devices 18a and 18b to access the web services 14a and 14b via the gateway 10. Gateway 10 may provision the wireless devices.

The plurality of user devices 18a, 18b comprise devices that are adapted to process at least data and may include voice and data processing functions. In one embodiment, shown in FIG. 1, the plurality of user devices 18a, 18b are wireless mobile devices. It should be appreciated that various types of devices may be used such as Personal Digital Assistants (PDAs), smart phones, etc. In an embodiment, the plurality of user devices 18 comprises Blackberry™ devices which are manufactured by Research In Motion Limited.

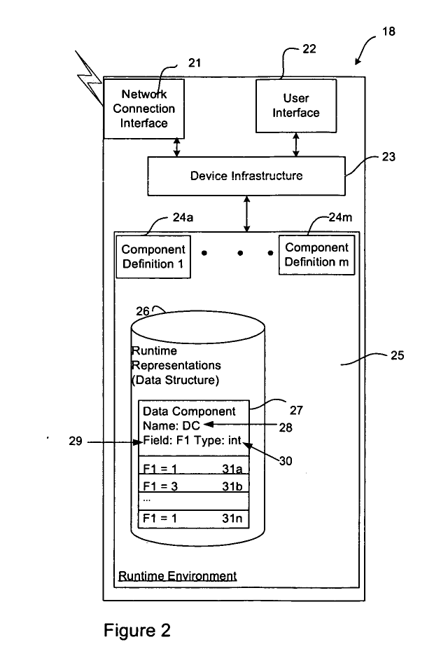

FIG. 2 is a block diagram of a wireless device 18 in accordance with an embodiment of the invention. The wireless device 18 includes a network connection interface 21 that is well known in the art and used to communicate wirelessly with the public domain carrier 12. The wireless device 18 further includes a user interface 22, which may be a keypad, a touch sensitive screen, voice recognition software, or any other user interface for wireless devices. A device infrastructure 23 includes memory, processor(s), peripheral ports, keypad, display and other hardware components required to support the functionality of the wireless device 18.

A runtime environment 25 provides basic resources and services and executes applications defined by the component definitions 24a-24m and other development artifacts of a component application. The runtime environment 25 may be configured as an intelligent container and the component applications comprise a plurality of component definitions which may include data component definitions, message component definitions, user interface/screen component definitions, script definitions, etc. typically in a structured definition language for instructing the execution of the runtime environment 25.

Component definitions 24a-24m typically use complex data structures containing objects and levels of nesting. Runtime environment 25 creates runtime representations 26 of the structures to facilitate execution of the application. For example, data component runtime instances are implemented in accordance with their respective descriptions. Data components typically have a name 28, and comprise one of more fields 29 (one is shown) of data having a type 30, which type may be a primitive type (e.g. byte, int, string, etc.) from a native language (e.g. Java) of the runtime environment 25 or other data types described by data component definitions. Instances 31a, 31b, 31n of the data component 27 are shown.

Processing these structures in a wireless device can entail significant memory and processing resources which may impact on the user experience. One often encountered requirement for such processing is the need to search data (e.g. the runtime representations) stored in temporary or persistent storage means coupled to the device 18 (e.g. of device infrastructure 23). In accordance with an embodiment of the invention as will be explained below, a definition aspect of the present invention is useful for data searching, filtering and sorting data stored by device 18, including runtime representations 26 such as the data component 27. Such searching, filtering and sorting may be occasioned in response to script constructs (e.g. a function) defined from script components (e.g. one or more of 24a, 24n) or within the component definitions (e.g. when creating representations of the component definitions themselves).

In accordance with an embodiment of the invention, runtime environment 25 may be adapted to receive and process requests to search, filter and sort data to provide a response where the requests conform to a definition:

[<fieldname> <operator> <value>][ORDERBY <fieldname_orderby> ASC/DESC]

Runtime environment 25 may include an interpreter (not shown) for receiving and processing such requests.

A request in accordance with the definition is comprised of two clauses, the first clause is for filtering (choosing instances of a data component based on a field of the data component) and searching (choosing particular values of the desired field) the data, and the second clause is for sorting the results of the first clause. It is possible to just search the data set using the first clause without ordering, or to order the entire data set without filtering, or to both filter and sort. The parts of the definition are:

<fieldname>: This specifies a field of the data component that is to be searched and is relative to the data component. It is possible, if the field is also a data type, to specify a field of the data field. This can be done to an arbitrary depth. That is some data are described with complex data structures of a plurality of levels of nesting of data structures. A particular field may have a field which has a field and so on.

Some data types may not be supported to such depth (e.g. array field types may not supported). Note that, if the field is a data type, only equal and not equal operators are supported.

<operator>: A logical comparator/operator. In accordance with the present embodiment the following operations are supported:

“=” (equal),

“<>” (not equal),

“<” (less than),

“>” (greater than),

“!=” (not equal),

“<=” (less or equal),

“>=” (greater or equal)

Only “=” and “<>” (“!=”) may be supported for fields that are data types.

<value>: Provides a value with which to compare instances of the field to select an instance of the data component. This value can be a static literal value, or a dynamic value. When a literal value is specified it may be delimited (e.g. enclosed in single quotes ‘ ’ or double quotes “ ”.

<fieldname_orderBy>: Instances of the data component retrieved by the search or the set of all instances may be ordered in accordance with a specified field name which may be different from the field searched. Only non-array fields are supported. Like <fieldname>, a search can specify a fieldname_orderBy field of data fields to an arbitrary depth.

ORDERBY: this is a keyword that denotes the beginning of the sorting clause.

ASC/DESC: The sort order may be specified as ASC (ascending) or DESC (descending) order.

Persons of ordinary skill in the art will appreciate that requests in accordance with the definition may be realized in many different forms and that the specific terms illustrated in the definition above need not be used. For example, a “Where” function for data components may be implemented using the definition. The following illustrates a sample search of component DC for instances thereof where fieldname “F1” has a value equal to the static value “1”:
DC.findWhere(“F1=‘1’”)

Instances 31a and 31b should be returned in response. A screen component may specify a where type clause using a global variable gv_InvValue having a value of “1”:
<choice . . . inValue=“@DCοF1=@gv_IntValue]” . . . />

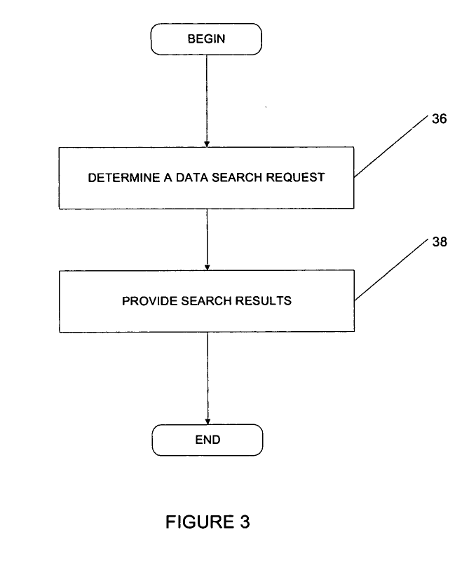

Now referring to FIG. 3, there is shown how a search is performed according to an embodiment of the invention. According to step 36 a data search request is determined (e.g. from a script). According to step 38, search results are provided.

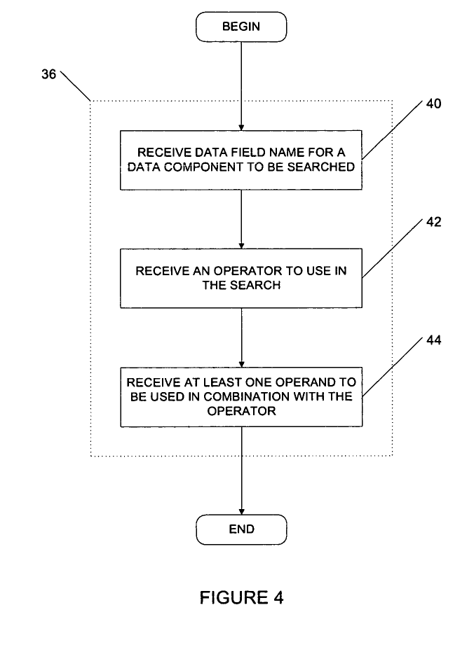

Now referring to FIG. 4, there is shown an embodiment which discloses how the data search request is determined 36 according to a first embodiment of the invention.

According to step 40 a data field name is provided for searching instances of a data component. According to step 42, an operator to use in the search is provided. It will be appreciated that the operator may be one of “=” (equal), “<>” (not equal), “!=” (not equal), “<” (less than), “<=” (less or equal), “>” (greater than) and “>=” (greater or equal).

According to step 44, an operand to be used in combination with the operator is provided. The operand may be either a static literal value or a dynamic value.

While steps 40, 42 and 44 are illustrated in a given sequence, the skilled addressee will appreciate that any sequence may be used for performing steps 40, 42 and 44.

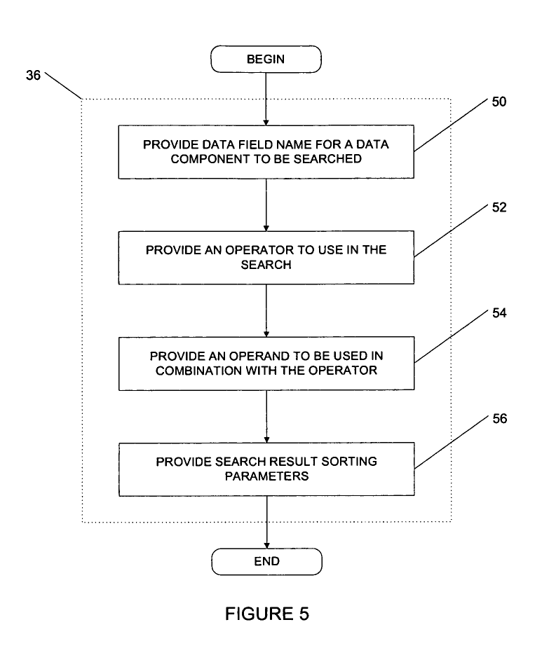

Now referring to FIG. 5, there is shown how a data search request is generated according to a second embodiment.

Steps 50, 52 and 54 correspond to steps 40, 42 and 44. However, according to step 56, search result sorting parameters are provided. The parameters are used for sorting the results from the search according to a desired result.

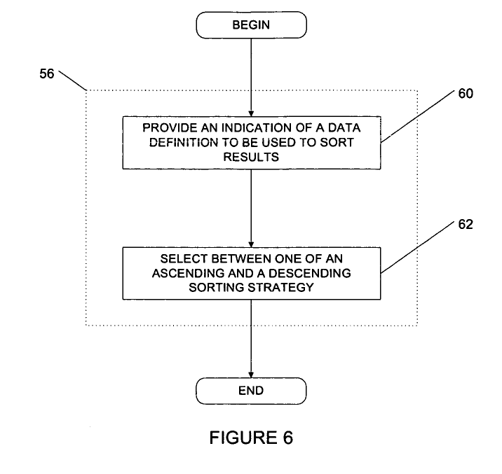

Now referring to FIG. 6, there is shown an embodiment which shows how search results sorting parameters are provided according to one embodiment of the invention. According to step 60, an indication of a field of the data definition to be used to sort the results for the search is provided. According to step 62, a selecting between one of ascending and a descending sorting strategy is made.

Runtime environment 25 interprets the request in accordance with the definition, and, if validly defined, executes same on the specified data component. Results, if any, are ordered as per the second clause, if any. In a further embodiment (not shown) only step 54 is performed to provide a manner of ordering/obtaining all data instances of a set without searching.

It will be appreciated that the method for performing a search disclosed uses a succinct and efficient language which is efficient therefore to minimize transmission size and parsing/processing requirements, while still covering the most common and useful search/filter/sort contingencies. Furthermore, it will be appreciated that the method disclosed allows filtering of a data set by comparing a field of an instance of the data against a static or dynamic value, then to optionally order the result set in ascending or descending order.

While illustrated in the block diagrams as groups of discrete components communicating with each other via distinct data signal connections, it will be understood by those skilled in the art that an embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment.

It should be noted that the present invention can be carried out as a method, can be embodied in a system, a computer readable medium or an electrical or electro-magnetical signal.

The embodiments of the invention described above are intended to be exemplary only. The scope of the invention is therefore intended to be limited solely by the scope of the appended claims.

We claim:

1. A method of searching data stored in a memory coupled to a processing device, the method comprising:
provisioning the processing device with computer executable code for:
accepting a request conforming to a definition for searching/filtering and ordering data, said definition comprising a first clause for specifying searching and filtering information to filter a data set in accordance with a single field of said set; and a second clause for specifying ordering information; and
performing data operations in accordance with said request to provide determined instances of data in response.

2. The method as claimed in claim 1, wherein any one of said first clause and said second clause is optional.

3. The method as claimed in claim 2, wherein the definition provides that a single field is compared to one of a static and a dynamic value.

4. The method as claimed in claim 3, wherein the data set is represented by complex data structure of a plurality of levels of nesting and wherein the definition provides for the specification of a single field of said complex data structure at any level.

5. The method as claimed in claim 4, wherein the order information includes a single order data field with which to order the instances of data in response.

6. The method as claimed in claim 5, wherein said definition provides that said searching and filtering information comprises an operator selected from the group consisting of “=” (equal), “<>” (not equal), “!=” (not equal), “<” (less than), “<=” (less or equal), “>” (greater than) and “>=” (greater or equal).

7. The method as claimed in claim 6, further comprising provisioning said processing device with computer code for defining a runtime environment for providing basic resources and services to execute component-based applications.

8. The method as claimed in claim 7, wherein said code for defining a runtime environment comprises code for defining runtime representations of components described by said definitions, said runtime representations comprising data to be searched.

9. The method as claimed in claim 8, wherein said code for defining a runtime environment comprises code for defining an interpreter for executing said request on said data in said runtime representations.

10. A method for performing a search in instances of a data component, said method comprising:
determining a data search request in accordance with a definition for lightweight data management to be performed on a single data field of said instances of said data component, comprising:
receiving said single data field;
receiving an operator to be used with the single data field; and
receiving at least one corresponding operand to be used with the operator; and
using the data search request generated to provide search results.

11. The method as claimed in claim 10, further comprising receiving search result sorting parameters and sorting search results accordingly.

12. The method as claimed in claim 11, wherein said receiving of said search result sorting parameters comprises receiving an indication of a field of said data definition to be used to sort results.

13. The method as claimed in claim 12, wherein said receiving of said search result sorting parameters further comprises receiving an indication to sort according to one of an ascending and a descending sorting strategy.

14. The method as claimed in claim 11, wherein said operator is selected from the group consisting of “=” (equal), “<>” (not equal), “!=” (not equal), (less than), “<=” (less or equal), “>” (greater than) and “>=” (greater or equal).

15. A method for specifying a data search request, comprising:
providing a data search request in accordance with a definition for lightweight data management to be performed on a single data field of a data component, comprising:
providing said single data field;
providing an operator to be used with the single data field; and
providing at least one corresponding operand to be used with the operator to instruct a search.
